(19) United States
(12) Patent Application Publication
(10) Pub. No.: US 2005/0249266 A1
(43) Pub. Date: Nov. 10, 2005

(54) Multi-subband frequency hopping communication system and method

(76) Inventors: Colin Brown, Ottawa (CA); Philip Vigneron, Kanata (CA)

Correspondence Address: TEITELBAUM & MACLEAN, 1187 BANK STREET, SUITE 201, OTTAWA, ON, K1S 3X7, CA

(21) Appl. No.: 11/119,780

(22) Filed: May 3, 2005

Related U.S. Application Data
(60) Provisional application No. 60/567,652, filed on May 4, 2004.

(51) Int. Cl. H04B 1/713

(52) U.S. Cl. 375/133; 375/260

(57) ABSTRACT

The invention provides an adaptive frequency hopping spread-spectrum (FHSS) transmission system and method, which efficiently utilizes available transmission bandwidth, whilst providing robustness to jamming techniques in wireless communication systems. The proposed technique operates by transmitting a wide-band signal over multiple, single-carrier, parallel transmission subbands, which may occupy non-contiguous frequency regions. The proposed scheme exhibits significant gain in error rate performance, as compared to a data rate equivalent single-subband system in the presence of signal jamming and/or interference without a reduction in the transmission data rate nor an increase in transmitter power. In addition, the proposed system and method are adaptive and enable more efficient use of the available bandwidth for communicating, thus increasing the overall bandwidth utilization of the system.

### CROSS-REFERENCE TO RELATED APPLICATIONS

The present invention claims priority from U.S. Provisional Patent Application No. 60/567,652 filed May 4, 2004, entitled “Adaptive Frequency Hopping . . . ”, which is incorporated herein by reference.

### TECHNICAL FIELD

The present invention relates in general to the field of radio communications and, in particular, to adaptive frequency hopping systems and methods for broadband radio communications.

### BACKGROUND OF THE INVENTION

Frequency hopping of a transmitted radio signal is used in a variety of spread-spectrum systems of wireless communications as it offers several advantages in both military and civilian applications. In a frequency hopping system, a coherent local oscillator is made to jump from one frequency to another, which limits performance degradation due to interference effects in a communications system, makes message interception more difficult, and lessens detrimental effects of channel collisions in multi-user systems. A description of this and other types of spread spectrum communications systems may be found, for example, in Spread Spectrum Systems, 2nd Ed., by Robert C. Dixon, John Wiley & Sons (1984) and Spread Spectrum Communications, Vol. II, by M. K. Simon et al., Computer Science Press (1985).

For military applications, frequency hopping is particularly important as the interference can take the form of signal jamming in addition to multi-path interference or multi-user interference typically present in civilian applications. The latter two forms of interference are commonly mitigated by including some form of channel equalization in the receiver, encoding and frequency domain multiplexing at the transmitter, or by adequately controlling the number of users in a given transmission area. In terms of signal jamming, however, conventional systems mitigate the effects of jamming by using either a combination of error correction coding, interleaving, and frequency hopping techniques including adaptive hopping sequences, or have to resort to scaling back the expected data rates in response to certain jamming waveforms. For example, to combat the effects of adaptive jamming waveforms, such as follower jammers which attempt to detect and adaptively follow frequency hopping of the communication system, the transmission scheme relies on the transmitter frequency hopping rate being greater than the tracking rate of the jammer.

Irrespective of the frequency hopping rate selected, conventional frequency-hopping spread spectrum systems may be easily jammed by a relatively simple jamming process, wherein several tones or Gaussian noise pulses are injected randomly among the frequency bins. This type of jamming, known as “partial-band” jamming, is recognized in the book by M. K. Simon et al., supra, to cause severe degradation in performance compared to other forms of interference. Partial-band jamming is especially damaging in the case when the jamming system (hereinafter “jammer”) is sophisticated enough to follow the signal with high probability. It may be difficult therefore to avoid performance degradation of conventional frequency hopping systems subjected to partial or full band jamming.

There is therefore a need to make frequency-hopped spread spectrum communications more robust in the presence of multiple tone or multiple Gaussian pulse jammers, partial and full band jammers.

In addition to the problems associated with providing anti-jamming capabilities, conventional wireless communication systems do not possess the ability to use the entire radio bandwidth in an adaptive and flexible manner, reflecting the highly-structured nature of legacy radio waveforms and of spectral allocation previously seen in military and civilian communications. This means that spectrum usage is often very fragmented and inefficient, with potentially large portions of the spectrum, though allocated, practically going unused.

The problem of efficient spectral usage is further exacerbated in modern wireless communications by the need to transmit high-bandwidth signals, for example combining audio and video information, or multiple data streams from multiple network users. One known method of wide-band wireless transmission is frequency domain multiplexing (FDM), in particular—orthogonal frequency division multiplexing (OFDM), which enables transmitting information from multiple users at multiple sub-carriers combined in a single OFDM signal. This method enables a multiple user access scheme wherein information from multiple users is transmitted in one contiguous block of frequency spectrum with a relatively high tolerance to multi-path interference. For a system employing frequency hopping, this results in a scheme wherein a wide-bandwidth contiguous-spectrum signal hops over the entire allocated radio bandwidth, with the aim of actively avoiding signal jamming waveforms. This approach however does not enable efficient and adaptive utilization of the entire non-contiguous and often highly-structured radio band available for transmission. Moreover, for certain types of signal jamming such as full or partial band jamming, a degradation in error rate performance or a higher required transmit power is still observed irrespective of the hopping rate of the transmitted signal.

U.S. Pat. Nos. 6,289,038 and 6,215,810 in the name of Park disclose a communication system combining FDM and frequency hopping, wherein, in order to increase robustness of the system against external interference, the same data is sent through several parallel hopping channels. A similar “frequency diversity” approach, in which replicas of the same data signal are sent over multiple frequency subbands, has been previously disclosed in a paper by E. Lance and G. K. Kaleh, entitled “A Diversity Scheme for a Phase-Coherent Frequency-Hopping Spread-Spectrum System,” IEEE Trans. Commun., vol. 45, No. 9, p. 1123-1129. However, the increased robustness to external interference in these systems is achieved at the expense of spectral utilization efficiency.

Accordingly, an object of the present invention is to provide a system and method of wireless communications wherein an initially broadband signal is divided into a plurality of narrower-band signals and transmitted over multiple frequency-hopping subbands each having a distinct frequency-hopping sequence for providing a performance gain through frequency diversity and an increased robustness to frequency jamming and mutli-path interference without sacrificing spectral utilization efficiency.

Another object of the present invention is to provide a system and method of wireless communications, wherein a broadband signal is divided into multiple narrower-band frequency-hopping subbands each of which has an adaptive frequency-hopping range spread over a full available non-contiguous band of radio frequencies for providing efficient and adaptive utilization thereof with increased robustness to frequency jamming.

It is another object of the present invention is to provide a system and method of adaptive wireless communications, wherein a broadband signal is divided into multiple frequency-hopping subbands having individually adjustable subband bandwidths and adaptive modulation parameters for providing efficient and adaptive utilization of available radio bands with increased robustness to interference.

### SUMMARY OF THE INVENTION

In accordance with the invention, a method of transmitting an input data stream having an input data rate via a radio link is provided, comprising the steps of: converting the input data stream into Q parallel data sub-streams S_{q} using serial-to-parallel conversion, wherein Q>1, q=0, . . . , Q−1, and wherein each of the Q parallel data sub-streams S_{q} carries a different portion of the input data stream, said portion defining a data rate of the sub-stream; for each data sub-stream from the Q parallel data sub-streams generating a carrier waveform having a hopping frequency and modulating the carrier waveform using the data sub-stream according to a modulation format to produce a frequency-hopping subband signal, said sub-band signal having a subband bandwidth related to the corresponding sub-stream data rate; and, forming a multi-subband frequency-hopping RF signal from the frequency-hopping subband signals for transmitting thereof via the radio link using an RF transmitting unit; wherein each of the frequency-hopping subband signals has a different frequency hopping sequence and a frequency hopping range, the frequency hopping ranges being such that at least two of the frequency hopping ranges have at least one common frequency.

In accordance with another aspect of this invention, a method is provided for receiving a multi-subband frequency-hopping RF signal, the method of receiving comprising the steps of: receiving the multi-subband frequency-hopping RF signal comprising a plurality of frequency-hopping subband signals, each centered at a different hopping frequency known to the receiver, with an RF receiving unit; converting the multi-subband frequency-hopping RF signal into a plurality of baseband signals corresponding to the plurality of frequency-hopping subband signals; extracting a plurality of parallel sub-streams of received data symbols from the plurality of baseband signals, wherein each of the parallel sub-streams is extracted from a baseband signal corresponding to a different frequency-hopping subband signal; and, combining the extracted plurality of parallel sub-streams of received data symbols into a sequential stream of data symbols using a parallel-to-serial conversion.

In another aspect of the present invention, a multi-subband frequency-hopping transmitter for transmitting an input stream of data is provided, comprising: input data conversion means for converting the input data stream into Q parallel data sub-streams using adaptive serial-to-parallel conversion, each of the Q parallel data sub-streams carrying a different portion of the input data stream, wherein Q is an integer greater than 1; waveform generating means for generating a frequency-hopping carrier waveform for each of the Q parallel data sub-streams, each of the frequency-hopping carrier waveforms having a different hopping frequency; modulating means for modulating each of the frequency-hopping carrier waveforms with a corresponding data sub-stream using a modulation format to produce Q frequency-hopping subband signals; an RF transmitting unit outputting the Q frequency-hopping subband signals for transmitting via a radio link to a receiver; wherein each of the frequency-hopping carrier waveforms has a distinct frequency hopping sequence and a frequency hopping range, the frequency hopping ranges being such that at least two of the frequency hopping ranges have at least one common frequency.

In another aspect of the present invention, a multi-subband receiver is provided for receiving a multi-subband RF signal comprising a plurality of frequency-hopping subband signals, the receiver comprising: an RF receiving unit for receiving the multi-subband RF signal and for converting each of the plurality of frequency-hopping subband signals into a baseband signal; data extracting means for extracting a plurality of parallel sub-streams of received symbols from the plurality of baseband signals; and, output data conversion means for converting the plurality of parallel sub-streams of received symbols into a sequential stream of data symbols using a parallel-to-serial conversion.

According to a feature of this aspect of the invention, the data extracting means comprises an A/D converter for obtaining a sequence of received waveform samples from each of the baseband signals by sampling thereof; channel estimating means for identifying a pilot sequence in at least one of the sequences of received waveform samples, and for providing subband-level channel estimation based on the identified pilot sequence; channel equalizing means for performing subband-level channel equalization upon each of the sequences of received waveform samples based on the subband-level channel estimation provided by the channel estimating means to form the plurality of parallel sub-streams of received symbols.

In accordance with another feature of the invention, the multi-subband frequency-hopping RF signal has an adaptive characteristic, the adaptive characteristic being one of: a number of the frequency-hopping subband signals in the multi-subband frequency-hopping RF signal, the frequency bandwidth of one of the frequency-hopping subband signals, the frequency hopping range of one of the frequency-hopping subband signal, the frequency hopping sequence of one of the frequency-hopping subband signal, and the modulation format for one of the frequency-hopping subband signal.

### BRIEF DESCRIPTION OF THE DRAWINGS

The invention will be described in greater detail with reference to the accompanying drawings which represent preferred embodiments thereof, wherein:

FIG. 1 is a diagram of a multi-subband frequency-hopping transmitter according to the present invention;

FIG. 2 is a diagram of subband frequency hopping sequences according to an embodiment of the present invention;

FIG. 3 is a diagram of a multi-subband receiver according to the present invention;

FIG. 4 is a graph of simulated BER performance for a conventional single-carrier communication system under PBN jamming;

FIG. 5 is a graph of simulated BER performance under PBN jamming for a 5 subband communication system having same total bandwidth as the system of FIG. 4;

FIG. 6 is a graph of simulated BER performance for a conventional single-carrier communication system under multi-tone jamming;

FIG. 7 is a graph of simulated BER performance under multi-tone jamming for a 5 subband communication system having same total bandwidth as the system of FIG. 6;

FIG. 8 is a graph of simulated BER performance under multi-tone jamming for multi-subband communication systems for varying number of subbands.

### DETAILED DESCRIPTION

The instant invention provides an adaptive multi-band method and system of transmitting and receiving a high data rate signal over multiple frequency-hopping subbands efficiently using a radio frequency (RF) band available for transmission, which may be discontinuous, whilst providing robustness to signal jamming and interference in wireless military or commercial communications. The system operates by dividing a single contiguous block of transmitted data over multiple, variable spectral bandwidth, parallel hopping modulated waveforms. Thus, each parallel hopping waveform consists of different data signals, which, when combined in the receiver, produce an effective bandwidth equivalent to that of a single contiguous block of frequency spectrum. This scheme differs from the aforementioned system proposed by Lance et al. for attaining frequency diversity by transmitting replicas of the data signal. Advantages of dividing the single contiguous block of data into parallel subbands include: i) it extends the transmitted symbol period and thus enhances robustness to multi-path interference; ii) it provides frequency diversity allowing an increased performance gain when used with interleaving and forward error correction; and, iii) it increases the system resilience to certain types of signal jamming e.g. continuous wave jamming. We have demonstrated, as will be described more in detail hereinafter, that in certain jamming scenarios there is an optimum number of subbands, with the optimum being, in general, greater than a single subband.

### DESCRIPTION OF EXEMPLARY EMBODIMENTS

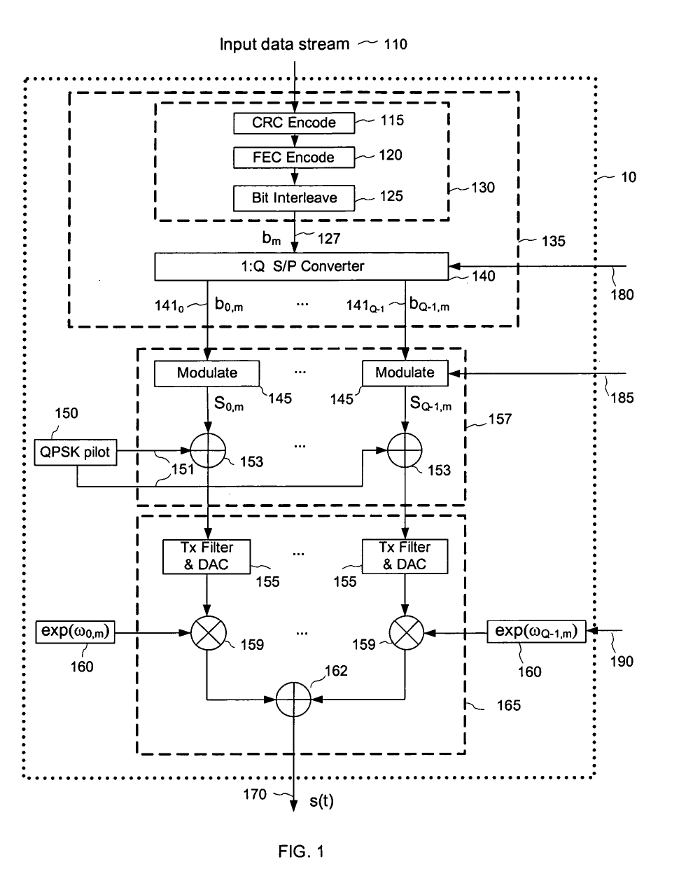

An exemplary embodiment of a multi-subband frequency-hopping transmitter of the present invention for transmitting an input data stream in multiple frequency-hopping RF subbands is shown in FIG. 1 and is hereafter described.

Each block in the diagram shown in FIG. 1 is a functional unit of the transmitter adopted to perform one or several steps of the method of multi-subband frequency-hopped transmission of the present invention in one embodiment thereof; these steps will be also hereinafter described in conjunction with the description of the corresponding functional blocks of the transmitter.

The multi-subband frequency-hopping transmitter 10 receives an input stream 110 of data symbols bᵢₙ=[ . . . b₁,b₂, . . . ] at an input data rate R bits/sec from an information source, and generates an RF signal s(t) comprising a plurality of modulated frequency-hopping subcarriers. The modulated frequency-hopping subcarriers are also referred to hereinafter as frequency-hopping subband signals, while the sub-carriers themselves are referred to hereinafter as carrier waveforms. In the embodiment described herein, the input data symbols bᵢ are binary symbols, or information bits; in other embodiments they can be any symbols suitable for transmitting and processing of digital information. The input stream of data symbols 110, also referred to hereinafter as the input data stream or as an input binary sequence, can carry any type of information, including but not limited to digitized voice, video and data.

The transmitter 10 includes input data conversion means 135 for converting the input data stream 110 into Q>1 parallel data sub-streams using serial-to-parallel conversion, each of the Q parallel data sub-streams carrying a different portion of the input data stream. Waveform generating means 160 generates a carrier waveform exp(iω_{q}(t)), wherein i=√−1, for each of the Q parallel data sub-streams, each of the carrier waveforms having a different hopping carrier frequency ω_{q}(t)=2πf_{q}(t) at every moment in time, wherein q=0, . . . Q−1 is a subband index. Modulating means 157 modulates each of the carrier waveforms with a corresponding data sub-stream using a pre-selected modulation format to form Q frequency-hopping subband signals. An RF transmitting unit 165 transmits the Q frequency-hopping subband signals via a radio link to a receiver.

The number Q of the subbands depends on a particular system implementation and on the transmission environment, such as transmission noise, external interference and RF bands allocated for the transmission. In the exemplary system embodiments described hereinafter in this specification, Q was found to be preferably between 2 and 8, and, most preferably, 4 to 6.

The modulation format used for each subband signal is preferably multi-level, such as M-QAM or CPM, with an adjustable and generally subband-dependent modulation order M. Hereinafter in this specification the modulation order of a q-th subband will be denoted as M_{q}.

Each of the sub-carriers “hops” in the frequency domain to another sub-carrier frequency f_{q,m} at time moments tₘ=t₀+m·T_{h,} wherein t₀ is an arbitrary time offset, Tₕ is a duration of a time interval between the hops when the sub-carrier frequencies remain constant, and m is a hop index; we will assume here for simplicity that m can take any integer value between −∞ and +∞, i.e. m=−∞, . . . ,+∞. The time-dependent hopping frequency of a q-th subband can be therefore described by the following equation (1):

$${f}_{q} ( t ) = {\sum }_{m = - ∞}^{m = ∞} {f}_{q , m} \cdot θ ( t - {t}_{m} ) , θ ( x ) = \{ \begin{matrix}1 , x ∈ [ 0 , {T}_{h} ) \\ 0 , x < 0 , x \geq {T}_{h}\end{matrix} \qquad ( 1 )$$

The sequence of frequencies f_{q}=[ . . . f_{q,m-1,}f_{q,m,}f_{q,m+1,} . . . ] for q-th subband will be referred to herein as a subband frequency hopping sequence. The time interval (tₘ, tₘ₊₁) between m'th and (m+1)'th consecutive hops will be referred to hereinafter as an m-th hop interval.

At each hop interval, the Q sub-carrier frequencies f_{q,m}, q=0, . . . ,Q−1, are selected pseudo-randomly to satisfy the following two conditions: 1) each of the sub-carrier frequencies has to be within a pre-determined subband frequency hopping range {f}_{q}, and 2) subband signals cannot overlap, i.e. |f_{q,m}−f_{q′,m}|>δ for all q≠q′, 0≦q, q′≦Q−1, wherein δ is a frequency guard preferably exceeding a subband signal bandwidth w_{q}. Condition (2) means that each of the frequency-hopping subband signals has a different frequency hopping sequence. A plurality of subband frequency hopping sequences [f_{q}], q=0, . . . , Q−1, satisfying the above stated conditions will be referred to herein as the plurality of pseudo-random orthogonal hopping sequences.

The subband frequency hopping ranges for at least two of the subbands, and preferably for the majority of the Q subbands, overlap with each other, making the communication system more resistant to external jamming. This overlap is an important feature of the instant invention, which distances it from previously disclosed systems wherein additional frequency bands can be allocated for high data rate channels, so that every channel is confined to a particular band. In contrast to this prior-art arrangement, the frequency-hopping subbands of the present invention preferably share, i.e. hop within the same frequency region, which can be either pre-allocated or dynamically assigned to the communication system of the present invention.

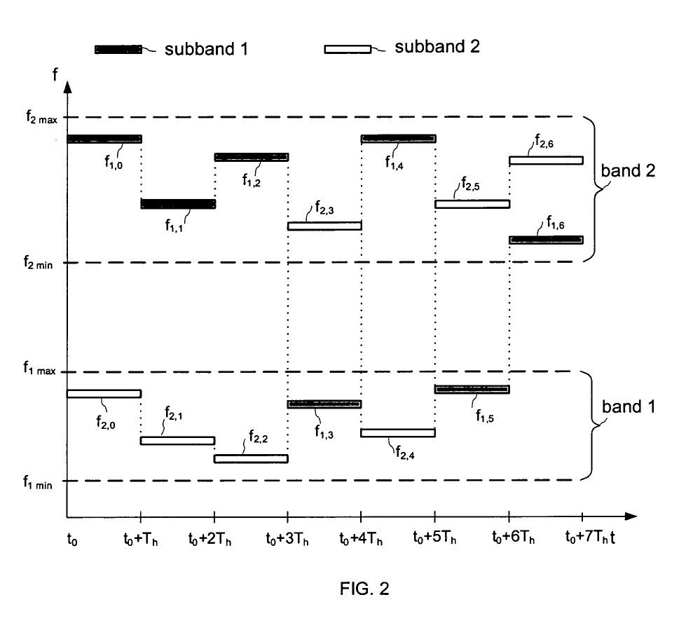

By way of example, FIG. 2 shows two frequency-hopping subbands of the present invention, labeled in FIG. 2 “subband 1” and “subband 2”, hopping within a non-contiguous frequency region B formed by two RF bands: B₁=(f_{1 min}, f_{1 max}) labeled “band 1” in FIG. 2, and B₂=(f_{2 min}, f_{2 max}) labeled “band 2”, so that B=B₁ ∪ B₂. At a time moment t₀, subband 1, which is shown by dashed stripes, has a sub-carrier frequency f_{1,0} located within the RF band 2, while subband 2, which is shown by open stripes, has a sub-carrier frequency f_{2,0} located within the RF band 1. At time moments tₘ=t₀+m·Tₕ, m=0, 1, . . . ,6, the subbands 1 and 2 hop to new frequency positions f_{1,m} and f_{2,m} respectively which are selected pseudo-randomly within the whole allocated RF frequency band B, with the limitation that the frequency-hopping subbands cannot overlap at any moment of time. In this example, the subbands 1 and 2 has the same non-contiguous frequency hopping range B, i.e. {f}₁={f}₂=B=(f_{1 min}, f_{1 max})∪(f_{2 min}, f_{2 max}), and at any given moment in time can be either in the same RF band or in different RF bands.

Advantageously, the splitting of the input stream of data in multiple frequency-hopping subbands according to the present invention can be made adaptive to a particular structure of RF bands available for transmission, wherein the number of subbands Q and data rates of the individual subbands, which determine their RF bandwidth, can be adjusted to better utilize the available RF bands. By way of example, the RF band 2 can be too narrow to accommodate a total bandwidth required for transmitting the input data stream without splitting thereof in subbands. In this case, the splitting of the input data stream into several narrow-band frequency-hopping subband signals opens up the RF band 2 for use by the communication system.

Turning back to FIG. 1, functioning of the transmitter 10 of the present invention according to one embodiment thereof will now be described more in detail.

The input data conversion means 135, which receives the input data stream 110 to be transmitted from a data source, is formed by an encoder 130, followed by an adaptive serial to parallel (S/P) conversion unit 140. The encoder 130 in this exemplary embodiment encodes the input stream of data symbols 110 in three stages. First, a sequence of N_{b} input information symbols from the input data stream is appended by a cyclic redundancy check (CRC) code of length c by a CRC encoding unit 115, and an appended bit sequence of length (N_{b}+c) is passed to a FEC encoder 120 wherein it is encoded by a forward error correction code of rate k/n producing code words of length n from every k bits input therein. Various FEC codes could be used here, and a person skilled in the art would be able to select an appropriate one for a particular system implementation. Generally, the FEC code and parameters n and k are selected together with other FEC parameters such as constraint length for convolutional codes to ensure that there exists a minimum free distance or Hamming distance between code words. In an exemplary embodiment, which performance is described hereafter in this specification, a conventional convolutional FEC code was used with the rate k/n=½, and a constraint length equal 4. This code is referenced in Table 8.2-1, page 492, of a text book “Digital communications, 4th Edition,” by John G. Proakis, McGraw-Hill, 2001, New York.

The encoded bit stream is then interleaved by the bit interleaving unit 125 to avoid bursts of errors in the receiver. The interleaving span is preferably selected to cover multiple subbands, as will be described hereinafter in more details. A resulting sequential stream of encoded binary data symbols 127 is fed to the adaptive S/P conversion unit 140 at a data rate R′=R·(n/k)·(1+c/N_{b}), wherein it is converted into Q parallel sub-streams of binary data, so that every symbol fed to the S/P converter 140 by the encoder 130 appears in only one of the Q parallel sub-streams 141₀, . . . , 141_{Q-1} of binary symbols, and each said sub-stream is formed from a different portion of the sequential stream of encoded binary data symbols 127 entering the S/P converter 140. The Q sub-streams of data will also be referred to hereinafter in this specification as Q data subbands.

The Q parallel sub-streams of binary data symbols are then fed into the modulating means 157, which in this embodiment are formed by Q modulating units 145, each followed by a transmit filter 155. The modulating units 145 convert their respective input binary sub-streams 141₀, . . . , 141_{Q-1} into sub-streams S_{q} of M_{q}-ary symbols, each symbol mapped onto μ_{q}=log₂(M_{q}) bits, the M_{q}-ary symbols used as complex modulation coefficients to modulate the frequency-hopping carrier waveforms generated by the local oscillators 160 using one of appropriate M-QAM modulation formats, for example a QPSK or a 16-QAM. In other embodiments, alternative multi-level modulation formats can be used, such as continuous phase modulation (CPM), with suitably configured modulating units 145 as would be known to those skilled in the art. Hereinafter in this specification, the parameter M_{q} will also be referred to as a symbol size, and as a modulation order when used as a modulation coefficient for modulating a carrier waveform.

To facilitate further understanding of the transmission system and method of this invention, the following definitions and notations will now be introduced. Let bₘ represent a sequence of binary bits inputted into the S/P converter 140 by the encoder 130, during an mₜₕ hop interval:
bₘ=[b_{0,0,0,m},b_{1,0,0,m}, . . . b_{μ}_{₀}_{,0,0,m},b_{0,1,0,m}, . . . ,b_{μ}_{_{q}}_{,N}_{_{Q−1}}_{,Q-1,m}], (2)
so that the sequential stream of encoded binary data symbols entering the S/P converter 180 is a sequence [ . . . bₘ₋₁, bₘ, bₘ₊₁, . . . ] of the sequences of binary bits bₘ for consecutive hop intervals. Let further b_{q,m} represent a corresponding q-th binary sub-sequence outputted from the S/P converter 140 from a qth output during an mₜₕ hop interval, q=0, . . . , Q−1, bₘ=[b_{0,m}, . . . ,b_{Q-1,m}]:
b_{q,m}=[b_{0,0,q,m},b_{1,0,0,m}, . . . b_{μ}_{_{q}}_{-1,N}_{_{q}}_{-1,q,m}]. (3)

The Q binary sub-sequences b_{q,m} are then mapped by the modulating units 145 onto Q sub-sequences s_{q,m} of M_{q}-ary symbols s_{k,m,q}, wherein k=0, . . . ,N_{q}−1, and N_{q} is the number of M_{q}-ary symbols in the q^{th} sub-sequence s_{q,m}:
s_{q,m}=s_{0,m,q},s_{1,m,q}, . . . ,s_{N}_{_{q}}_{-1,m,q}], for q=0,1, . . . Q−1, (3)
so that each of the Q sub-streams S_{q} is formed by the sub-sequences s_{q,m} for consecutive hop intervals: S_{q}=[ . . . , s_{q,m-1}, s_{q,m}, s_{q,m+1}, . . . ].

Symbol b_{n,k,q,m} in equations (2) and (3) denotes the n^{th} bit mapped onto the k^{th} QAM symbol in the q^{th} sub-sequence s_{q,m} for the m^{th} hop duration, n=0, . . . , μ_{q}−1 . The number of bits N_{b} in the sequence bₘ, or its length, is given by equation (4):

$${N}_{b} = {\sum }_{q = 0}^{Q - 1} {N}_{q} {μ}_{q} , \qquad ( 4 )$$

wherein the product N_{q}·μ_{q} are the number of bits into the q^{th} sub-sequence b_{m,q}:N_{b q}=N_{q}·μ_{q}.

The S/P converter 140 divides each input binary block bₘ into Q portions of length N_{b q} each, q=0, . . . , Q−1, and sends each portion to a different data sub-stream, or subband. In one exemplary embodiment, the P/C converter 140 divides each block bₘ of N_{b} bits input therein between the Q subbands in equal fractions, with N_{b q}=N_{b}/Q bits from the block bₘ per subband, each of the data subbands having than the same data rate of R′/Q bits per second.

In a preferred embodiment, however, the S/P converter 140 is capable of adjusting the fractions η_{q}=N_{b q}/N_{b} of the input block of symbols bₘ sent to individual output sub-sequences b_{q,m}, the fractions η_{q} also known as splitting ratios, which therefore can differ from one another. This enables adjustment of the data rates R_{q}=η_{q}·R′ of the individual sub-streams, and the associated subband frequency bandwidths w_{q}, thereby enabling better adaptation of the communication system to the transmission environment of the radio link.

Furthermore, in the preferred embodiment the modulating units 145 are adaptive, so that not only the sub-stream data rates R_{q}, but also the modulation formats, e.g. modulation orders M_{q}, can be adjusted, thereby advantageously enabling further adjustment of frequency bandwidths w_{q} of individual subbands to optimize the transmission system performance for a particular transmission environment and available RF transmission bands.

In a next step, a pilot sequence of symbols provided by a pilot sequence generator 150 is added to each subband prior to the information-bearing sub-sequence s_{q,m} during each hop interval, as schematically shown in FIG. 1 by arrows 151, to be used at the receiver for subband-level channel estimation, as will be described hereinafter. The pilot generators 150, together with summation units 153, will also be referred to hereinafter in this specification as pilot insertion means. Pilot sequences for channel estimation, as well as pilot insertion means, are well known in the art, and their particular implementation will not be described herein in any further detail. In some embodiments, e.g. if the transmission channel characteristics are expected to be fairly uniform across the available RF frequency band, or/and are expected to vary with time only slowly compared to a hop interval Tₕ, the pilot sequences can be inserted not in every subband, and/or not for each hop interval. The pilot sequences added to different subbands can be identical or they may differ, e.g. depending on the subband data rate and/or expected subband noise and interference in the communication link.

By way of example, in the exemplary embodiment considered herein, the pilot sequences are identical QPSK symbol sequences which are inserted at the beginning of each of the Q information-bearing sub-sequences s_{q,m} to form Q parallel sub-streams of complex data symbols.

Finally, these Q parallel sub-streams of complex data symbols are sent to the RF transmitting unit 165, which is embodied using a bank of Q DAC/Tx filter units, followed by Q RF mixers 159 and an RF combiner 162. The Q parallel sub-streams of complex data symbols are digitized and shaped in the frequency domain by adaptive transmission filters incorporated in the D AC/Tx filter units 155, and used by RF mixers 159 to modulate the frequency-hopping harmonic signals, or carrier waveforms, provided by the signal generators 160, which include local oscillators and frequency controllers defining the Q pseudo-random hopping frequencies of the respective subbands.

The resulting frequency-hopping subband signals are combined by the RF signal combiner 162 into one multi-subband frequency-hopping signal. This signal can then be further frequency up-converted as required, and then transmitted over the communication link with an antenna.

The resulting transmitter signal s(t) at the output of the transmitter can be written as:

$$s ( t ) = {\sum }_{m = - ∞}^{m = ∞} {\sum }_{q = 0}^{Q - 1} θ ( t - {t}_{m} ) Re \{ {s}_{q , m} ( t ) {ⅇ}^{{ⅈω}_{q , m} ( t )} \} , . \qquad ( 5 )$$

where θ(t) is a unit amplitude rectangular pulse of a duration Tₕ, which is defined in equation (1), Re{●} represents the real part of {●}, ω_{q,m} are the hopping frequencies for each subband, which are selected to ensure negligible adjacent carrier interference and can vary for each hop interval. The complex time-dependent modulation functions s_{q,m}(t) are the frequency-shaped transmitted symbol sub-sequences s_{q,m} in the mth hop interval, which can be described by the following equation (6):

$${s}_{q , m} ( t ) = {\sum }_{j = 0}^{{N}_{q - 1}} {s}_{q , m} ( j ) {g}_{q} ( t - {t}_{m} - {jT}_{q} ) , q = 0 , … , Q - 1 \qquad ( 6 )$$

where T_{q} is the symbol period for the q-th subband signal, and g_{q}(t) is the impulse response of the pulse shaping filter of the q-th subband. In the exemplary embodiments for which simulation results are provided hereinafter in this specification, the filter g(t) is a root raised cosine filter with a roll-off factor β=0.22.

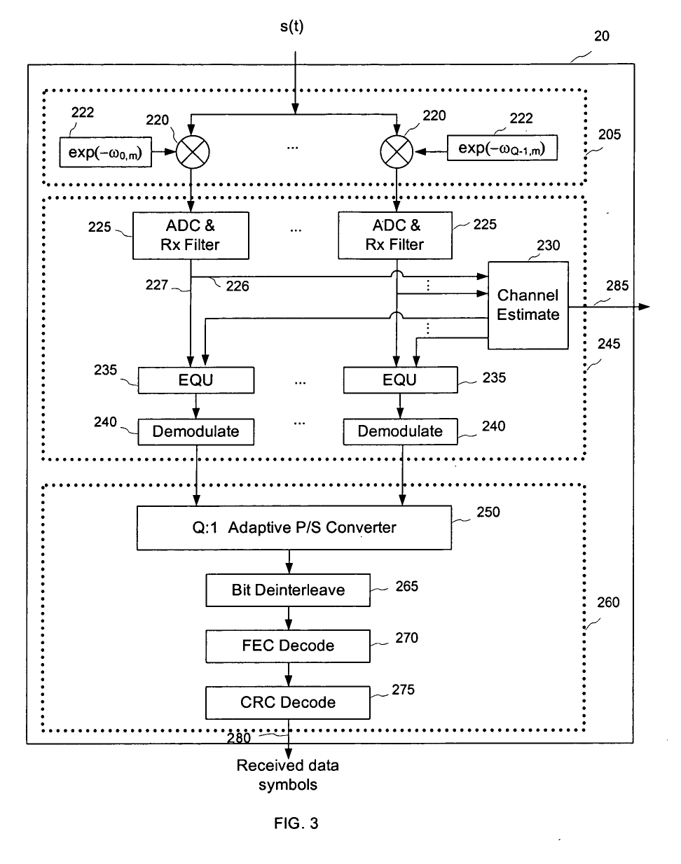

The various functional units shown as blocks in FIG. 1 , as well as the corresponding functional units having similar functions which are shown in FIG. 3 described hereinbelow, can be integrated or separate structures implemented in either software or hardware or a combination thereof commonly known to provide the aforedescribed functionalities, including DSPs, ASICs, FPGAs, and analogue RF, HF and UHF circuitry. For example, the data conversion means 135, the modulating means 157 and the pilot generator 150 are preferably implemented in digital hardware, namely a DSP/FPGA chipset programmed with a corresponding set of instructions. The carrier waveform generators 160, and similar generators 222 shown in FIG. 3, can be implemented as a digital generator which generates the digitized frequency-hopping sinusoidal carrier waveforms and outputs them through an incorporated D/A converter to the analogue RF mixers 159 and 220. Alternatively, the generation of the frequency-hopping sinusoidal carrier waveforms can be achieved using an analogue phase locked loop (PLL) having a reference digital input to define the discrete hopping frequencies. The RF transmitting unit 165, and a corresponding RF receiving unit 205 shown in FIG. 3, is preferably implemented using analogue circuitry due to the high transmission frequencies involved, as would be obvious to those skilled in the art.

Additionally, as those skilled in the art would appreciate, the RF transmitting unit 165 can include an additional RF mixer following the signal adder/combiner 162 and an additional HF or UHF carrier generator for frequency up-conversion of the frequency-hopping subband signals when required, for example into one of the 300 MHz, 2.4 GHz or 5 GHz bands, followed by a power amplifier and an antenna. These additional blocks are commonly employed in RF transmitters and are not shown in FIG. 1.

By way of example, a multi-subband communication system including the transmitter 10 of the present invention has a total operating bandwidth of 100 MHz. The signal combiner 162 outputs a multi-subband frequency-hopping signal in the frequency range 0 Hz-100 MHz. This intermediate-frequency (IF) signal is then multiplied by an additional RF carrier signal, for example a 2 GHz, 5 GHz, or 300 MHz carrier. As would be obvious to those skilled in the art, image rejection filters can be inserted in the signal paths following each of the aforementioned mixers, e.g. the mixers 159, and the adder 162, to reject all frequencies outside of the corresponding operating bandwidths.

The transmitter output signal s(t), after propagating though the radio communication link where it experiences linear distortions and external signal interference in the form of additive noise and, possibly, jamming, is received by a multi-subband receiver of the present invention adapted for converting the frequency-hopping multi-subband RF signal into a binary sequence closely approximating the input binary sequence 110 inputted into the transmitter 10 as described hereinabove. An embodiment of the multi-subband receiver of the present invention for receiving a stream of data symbols transmitted using the aforedescribed transmitter, is shown in FIG. 3 and will now be described.

Similarly to FIG. 1, each block in the diagram shown in FIG. 3 is a functional unit of the receiver adopted to perform one or several steps of the method of receiving of the multi-subband frequency-hopped signal of the present invention in one embodiment thereof; these steps will be also hereinafter described in conjunction with the description of the corresponding functional blocks of the receiver.

The multi-subband receiver 20 includes an RF receiving unit 205, which is formed by an RF antenna (not shown), a 1:Q RF splitter followed by Q local oscillators 222 and Q RF mixers 220. The local oscillators 222 are synchronized to the corresponding local oscillators 160 of the transmitter, and, when the multi-subband frequency-hopping RF signal comprising a plurality of frequency-hopping subband signals each centered at a different hopping frequency f_{q,m} known to the receiver 20 is received, produce harmonic RF signals following the same subband hopping frequency sequences f_{q,m} as those used by the transmitter 10. The RF receiving unit thereby converts the received multi-subband frequency-hopping RF signal into a plurality of baseband signals r_{q,m}(t) corresponding to the plurality of frequency-hopping subband signals. Assuming a perfect transmitter-receiver synchronization, the resulting qth baseband signal r_{q,m}(t) at the output of the RF receiving unit 205 during the m-th hop interval satisfies the following equation (7):

$${r}_{q , m} ( t ) = {\sum }_{m = - ∞}^{∞} {\sum }_{l} {s}_{q , m} ( t - {τ}_{l} ( t ) ) {h}_{q , m} ( {τ}_{l} , t ) + {w}_{q , m} ( t ) + {J}_{q , m} ( t ) \qquad ( 7 )$$

where h_{q,m} (τₗ, t) represents a time variant complex channel gain at a transmission delay time τₗ, w_{q,m}(t) represents additive white Gaussian noise with a two-sided spectral density of N₀/2, and J_{q,m}(t) is an additive jamming and/or interference signal present in the qth subband and the mth hop interval.

The Q parallel baseband signals r_{q,m}(t), q=0, . . . ,Q−1, are then passed onto data extracting means 245 for extracting Q parallel sub-streams of received data symbols therefrom, so that each of the parallel sub-streams of received data symbols is extracted from a different baseband signal. The data extracting means 245 are formed in this embodiment by a bank of receive filter/ADC units 225, one unit per received subband followed by a subband channel equalizer 235 and a demodulating unit 240. They can be implemented in digital hardware, namely a DSP/FPGA chipset programmed with a corresponding set of instructions.

Each of the receive filter/ADC units 225 includes a pulse-matched filter and an A/D converter. A qth baseband signal is first sampled therein at a sampling rate 1/Tₛ preferably exceeding the symbol rate 1/T_{q} by an oversampling factor T_{q}/Tₛ>1, and then filtered by the corresponding pulse matched filter. The output of each of the ADC/Rx filter units 225 during the mth hop is a sequence of received waveform samples y_{q,m}(n) down-sampled to the symbol rate 1/T_{q}, which is given by the following equation (8):

$${y}_{q , m} ( n ) = {\sum }_{l = 0}^{L - 1} {s}_{q , m} ( n - l ) {f}_{q , m} ( l , n ) + {I}_{q , m} ( n ) , \qquad ( 8 )$$

where n is a time sample index, mN_{q}<n<(m+1)N_{q}, f_{q,m}(l,n) is an equivalent low-pass complex digital filter function representing a combined filtering effect of the transmit filter g_{q}(t), the communication channel h_{q,m}(t) and the receiver filter g*_{q}(−t), where the asterisk “*” represents the complex conjugation operation, which is matched to the transmitter, for the qth subband during the mth hop, I(n) represents the sampled additive combination of the interference terms J(n) and w(n) filtered by the corresponding receiver matched filter 225, and L represents a multi-path delay spread of the radio link over all subband channels.

The output y_{q,m}(n) of each of the ADC/Filter units 225 is then forwarded to a channel estimating unit 230, and, in parallel, to a corresponding subband equalizer 235, as schematically shown by arrows 226 and 227 for one of the receiver subband chains. The channel estimating unit 230 is programmed to identify the pilot sequences in the sequence of received waveform samples for each subband, to perform subband-level channel estimation, i.e. to estimate the equivalent channel filter, f_{q,m}(l,n) and to supply the channel estimation information to a corresponding equalizer 235. The channel equalizers 235 then use the subband-level channel information provided by the channel estimator 230 to extract Q parallel sub-sequences of M_{q}-ary symbols s_{q,m}=[s_{q,m}(n), n=mN_{q}, . . . , (m+1)N_{q}], q=0, . . . , Q−1, for each hop interval, the Q parallel sub-sequences forming Q parallel sub-streams of recovered data symbols s_{n,q,m} over consecutive hop intervals.

Each of the Q parallel sub-sequences s_{q,m} of the M_{q}-ary data symbols recovered during mth hop interval is then forwarded to a respective demodulator 240, which functions to reverse the aforedescribed action of the modulators 145 of the transmitter 10 shown in FIG. 1. Namely, the demodulators 240 map each of the recovered M_{q}-ary data symbols s_{q,m}(n) to a block of μ_{q} bits, thereby producing Q parallel binary sub-sequences b_{q,m}, q=0, . . . , Q−1, for each hop interval. The Q parallel binary sub-sequences b_{q,m} are then fed into output data conversion means 260, which converts the Q parallel binary sub-streams [ . . . b_{q,m}, b_{q,m+1}, . . . ], q=0, . . . , Q−1, into a sequential stream of binary data symbols approximating the binary input stream of data symbols 110 of the transmitter 10. For the system embodiment described herein, the data conversion means is formed by a parallel-to serial converter 250, which combines the Q parallel sub-streams of received data symbols into a sequential stream of data symbols using a parallel-to-serial conversion, followed by a 3-stage decoder mirroring the encoder 130 of the transmitter 10, i.e. including a bit de-interleaving unit 265, a FEC decoder 270 and a CRC decoder 275. The output data conversion means 260 can be implemented in the same DSP/FPGA chipset as the data extracting means 245, or using a separate DSP.

A number of methods of channel estimation and equalization known in the art can be effectively implemented in the channel estimating and channel equalizing units 230 and 235 in accordance with the present invention. The channel estimating and channel equalizing units 230 and 235 can be embodied using appropriate instruction sets programmed into the same DSP/FPGA chipset at the data extracting block 245, or using a separate processor. Advantageously, the multi-subband transmission scheme of the present invention enables an embodiment wherein the channel equalization for high data rate signals is simplified compared to a conventional single carrier system, which is described hereinbelow.

Indeed, the method of the present invention enables transmitting the high data rate signal, which would occupy a wide transmission bandwidth for the conventional system, over multiple narrow subbands. These subbands can be formed so that each of the subband bandwidths w_{q}, q=0, . . . , Q−1, is less than the coherence bandwidth of the communication channel, thereby ensuring that the equivalent transmission channel for each individual subband frequency is flat. This implies that f_{q,m}(l,n)=f_{q,m}(n)δ(l), where δ(●) is the Kronecker delta function, and the equivalent low pass filter f_{q,m}(l,n) satisfies the following equation (9):
f_{q,m}(n)=α_{q,m}(n)e^{-jθ}^{_{q,m}}⁽ⁿ⁾ (9)

The hopping rate 1/Tₕ is preferably sufficiently large so that the hopping period Tₕ is much smaller than a coherence time T_{c} of the channel, and the channel can be described with a gain coefficient that remains constant over one hop interval; therefore the parallel sequences of waveform samples y_{q,m}(n) input to the equalizers 235 during mth hop interval satisfy a simpler equation (10):
y_{q,m}(n)=s_{q,m}(n)a_{q,m}+I_{q,m}(n), mN_{q}<n≦(m+1)N_{q} (10)
where a complex coefficient a_{q,m}=α_{q,m}e^{-jθ}^{_{q,m}} represents the complex channel gain which remains constant over the hop interval. Equation (10) holds if the complex channel gain coefficients a_{q,m} and a_{u,v} are uncorrelated for q≠u and m≠v, which is typically a valid approximation for the pseudo-random frequency hopping sequences.

The channel estimating unit 230 in this embodiment estimates the term a_{q,m} in the received signal by extracting channel information from the pilot symbols and then averaging over all pilot symbols in a hop interval, to produce a channel gain estimate â_{q,m} which is forwarded to the gain equalizing unit 235.

In a frequency-flat slow fading channel, the averaging of pilot information reduces the noise of the channel estimate. However, the received signal may be still corrupted by the additive interference termI(n), of which the jamming signal, when present, has a dominant effect in the degradation of the BER performance of the transmission system.

Advantageously, the method of the present invention, wherein the input data stream 110 is transmitted over multiple substantially independent frequency-hopping subbands, allows to adaptively change one or several characteristics of the transmitted multi-subband signal to better adapt to the transmission environment, thereby further optimizing the transmission performance.

By way of example, in one embodiment the channel estimation unit 230 is programmed to perform subband-level estimation of a transmission quality characteristic for each subband signal for a hop interval, and then forms from said characteristics a feedback signal F. This feedback signal is then outputted from a communication port 285 for communicating to the remote transmitter 10 over the communication link using either a virtual channel setup within a data stream of a reverse channel, or using a dedicated control channel as known to those skilled in the art. The subband-level transmission quality characteristic computed by the channel estimation unit 285 can be, for example, a signal to interference-plus-noise ratio (SINR) computed from the subband sequences of the waveform samples y_{q,m}(n) by estimating energies of the non-signal, i.e. “interference plus noise” component I_{q,m}(n), and the signal, or data component thereof s_{q,m}(n), and computing their ratio. Various methods of SINR estimation are known, and adapting them for the system of this invention would be obvious to one skilled in the art. The feedback signal F is then communicated to the transmitter 10 and passed to at least one of the S/P converter 140, the Q modulating units 145, and the frequency controllers of the signal generators 160, as illustrated by the arrows 180, 185 and 190 in FIG. 1, for adaptively adjusting at least one of: i) the number Q of the frequency-hopping subband signals, and ii) the bandwidth w_{q}, frequency hopping range, frequency hopping sequence, or modulation format of one of the frequency-hopping subband signals. In an alternative embodiment, the subband-level transmission quality characteristic can be an error rate estimate per subband per hop interval Rₑᵣᵣ(q,m). These estimates can be obtained by inserting in the receiver 20 shown in FIG. 3, an optional CRC decoder, or any other suitable decoder capable of outputting Rₑᵣᵣ(q,m) values, after each of the demodulator units 240 and before the adaptive P/S converter 250, with a set of corresponding encoders inserted in the transmitter 10 before each of the modulator blocks 145.

An article entitled “Adaptive use of Spectrum in Frequency Hopping Multi-Band Transmission,” published in Proc. IST-054 Symposium on Military Communications, Apr. 18-19, 2005, and incorporated herein by reference, which is authored by the inventors of the present invention, discloses an adaptive method of selecting regions of the available RF frequency band with little or no jammer power for transmitting the multi-subband frequency-hopping RF signal of the present invention, thus actively avoiding areas of the RF spectrum with relatively large jammer and/or interference signals I(n).

However, even without adaptive spectrum selection techniques, a considerable gain in the BER performance is still achieved using the multi-subband transmission approach of the present invention in comparison to a conventional single carrier system, due primarily to the frequency hopping nature of the transmission scheme and the inherent time diversity achieved by interleaving over multiple parallel subbands.

Simulation Results

Results of computer simulations of a communication system of the present. invention including the aforedescribed multi-subband frequency-hopping transmitter and the multi-subband receiver of the present invention will now be presented. In the simulations, the performance of a conventional single subband communication system was compared with a number of implementations of the multi-subband system of the present invention in a variety of jamming scenarios. The modulation format used in simulation was QPSK , corresponding to M_{q}=4 for all subbands. The communication channel was modeled as distortion-free with additive white Gaussian noise. Except where indicated, the results presented hereinbelow show BER performance for un-coded waveforms, so that the effects of jamming can be more readily quantified. The observed performance trends can be extrapolated to higher order linear modulation formats, and also to non-linear modulation formats, such as continuous phase modulation (CPM).

Partial Band Noise (PBN)

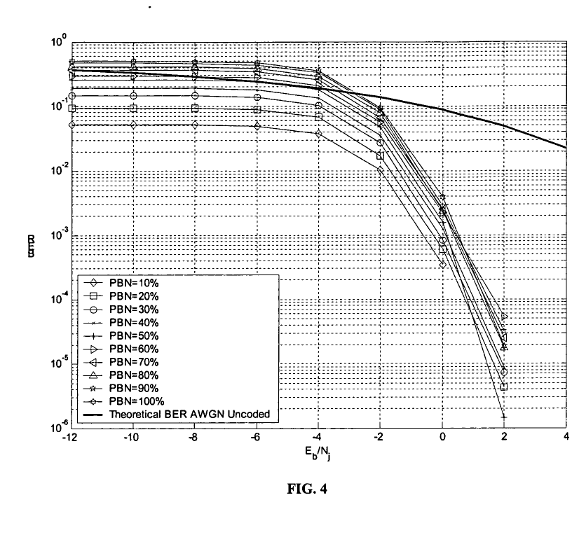

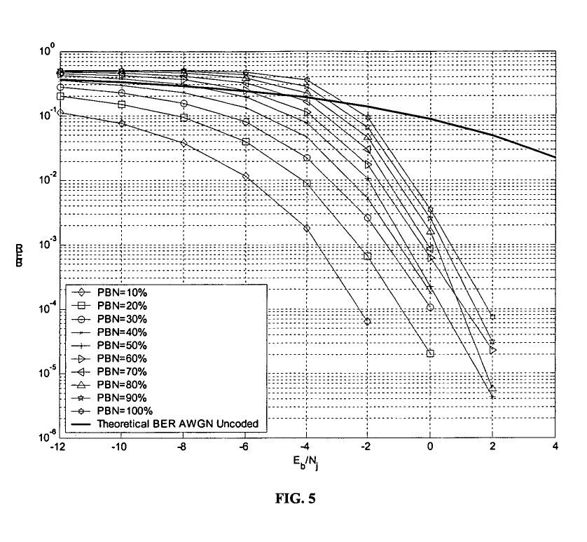

FIGS. 4 and 5 show the bit error rate (BER) performance of a conventional single-carrier system having a single 5 MHz transmission bandwidth, hereinafter referred to as the 1×5 MHz system, and an equivalent multi-subband system of the present invention transmitting the same information over five 1 MHz subbands respectively, hereinafter referred to as the 5×1 MHz system, when subject to partial band noise jamming. The total UHF operating bandwidth was 175 MHz, and the frequency hopping rate for the simulations was 1000 hops per second. PBN jamming was simulated by adding a white Gaussian noise jamming signal, over the band of interest, for a residual signal-to-noise ratio Eb/N0=10 dB. The BER curves in FIGS. 4 and 5 represent the performance when a varying percentage of the operating band is subject to jamming; thus PBN=100%, which is equivalent to full band noise (FBN) jamming, means that the entire operating band was subject to jamming, and hence, for this case, the BER performance will be equivalent for all multi-band transmission schemes.

To illustrate the potential BER advantage of using multiple subbands, FIGS. 4 and 5 show the performance for QPSK modulation with a rate ½ convolutional FEC code. In FIG. 4, the BER performance for various PBN jamming appears to track the 100% jamming curve closely. In contrast to this feature of the conventional single-carrier system, the jamming curves in FIG. 5 depicting results for the 5-subband system of the present invention, are spread out as a function of the percentage PBN. Comparing the two figures, a clear gain in BER performance for the 5×1 MHz system can be observed in a wide range of band noise coverage.

The observable gain in BER performance can be attributed to the frequency diversity effect provided by the method of the present invention, which enables the recovery of additional errors when a fraction of the subbands is jammed. A further diversity gain in the multi-subband scheme of the present invention is achieved due to the bit interleaving performed by the encoder block 125 in FIG. 1, when the interleaving span, i.e. a time delay between two originally neighboring bits in the output of the interleaver 125, is large enough to span multiple subbands, or frequency dwell times. The frequency diversity provided by the multi-subband transmission according to the method of the present invention, when combined with this large-span interleaving following by the de-interleaving step 265 at the receiver 20, enables the receiver 20 to recover bursts of errors arising when a subband hops to a “jammed” portion of the transmission band, at a cost of adding a fixed time delay equal to the interleaving span at the receiver. Expanding the interleaving span further over multiple hop intervals enables attaining additional performance gains by exploiting both the time and frequency diversity.

Multi-Tone Jamming

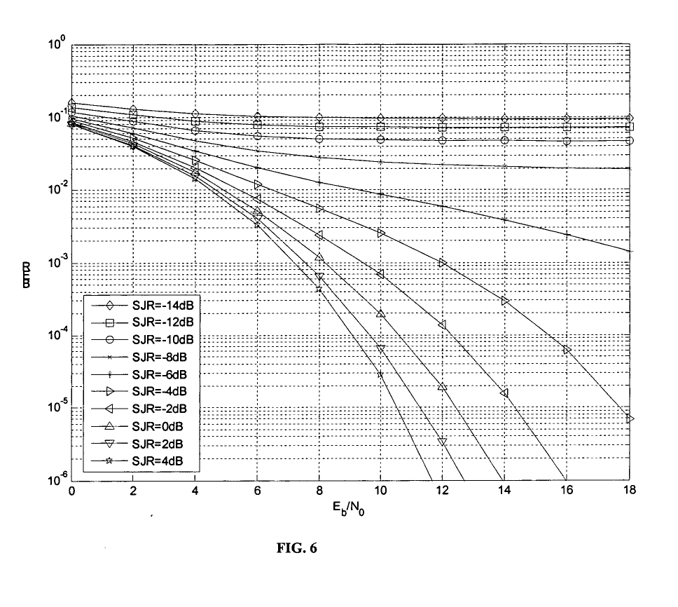

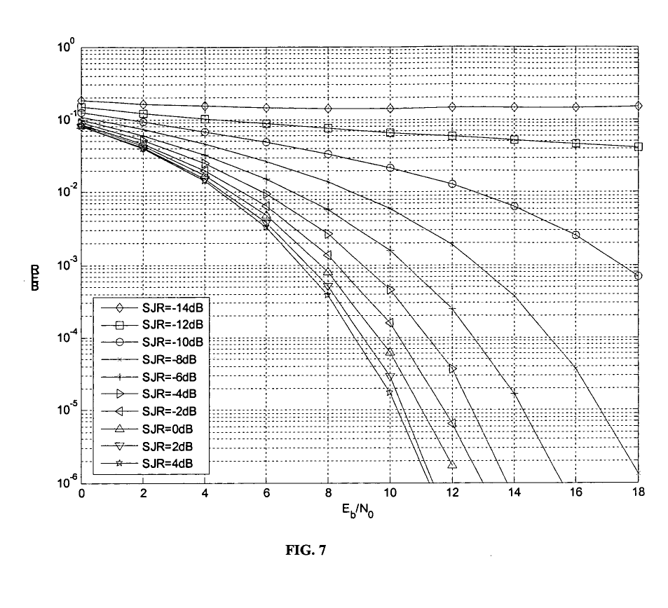

FIGS. 6 and 7 show the BER performance of the 1×5 MHz system and the 5×1 MHz system respectively, subject to multi-tone (MT) jamming. The jammer waveform consisted of 175 jamming tones evenly distributed over the UHF operating band. The figures clearly show that, as the signal to jammer ratio (SJR) is decreased, the 5×1 MHz scheme of the present invention is more robust to this particular form of jamming compared to the conventional 1×5 MHz scheme, with the limiting case on performance for the conventional system being for a SJR=−8 dB. The results shown in FIG. 6 demonstrate that for a single subband scheme an SJR=−8 dB yields an irreducible error floor in the BER performance and thus makes the scheme unsuitable for reliable communications. In contrast, FIG. 7 shows that the multi-band scheme increases tolerance to jamming by 4 dB in SJR compared to the single wideband transmission for the same total bit rate, at no increased cost in bandwidth or power.

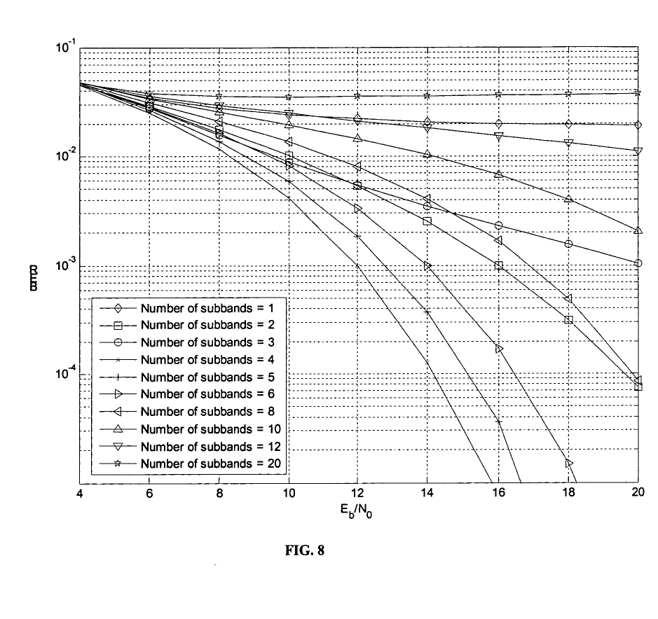

FIG. 8 shows the BER performance in multi-tone jamming as a function of the number Q of subbands used, with Q varying from 1 to 20. The total occupied signal bandwidth for the simulation results remains fixed at 5 MHz, such that each of the Q subbands has a bandwidth w_{Q}=5 MHz/Q. This ensures that the data rate of the system is approximately equal for all multi-subband systems tested. An important observed feature was that the BER improvement is not a monotonic function of the number of subbands Q, but there is an optimum number Q of subbands where the BER is lowest, which for the simulated system embodiment was 4 subbands. The worsening of the BER performance when the subband number Q increases above the optimum can be explained as follows: for a given total emitter power, the power per subband is a function of the number of subbands used in transmission. Thus, as the number of subbands increases, the subband bandwidth and signal power per subband decreases, resulting in subband signals which are more sensitive to jamming waveforms when the hopping frequencies coincide with jammed regions of the spectrum. This means that an optimum number of subbands will exist, dependent on the jamming environment encountered. For the multi-tone jamming waveform set at SJR=−8 dB, FIG. 8 shows that the optimum number is four subbands each of 1.25 MHz bandwidth (4×1.25 MHz). Such an optimum Q was found to exist even when the hopping frequencies are adaptively selected to minimize jamming. Depending on a particular implementation and system requirements, the optimum Q is from 2 to 8 for most, although not necessarily all, systems according to the present invention. The optimum Q, however, is expected to rise, e.g., with increasing of the input bit rate.

The aforedescribed simulation results demonstrate that the adaptive frequency hopping multi-subband communication system and method described hereinabove in this specification efficiently utilize available transmission bandwidth, whilst providing robustness to jamming techniques. In the presence of PBN jamming, the multi-band scheme combined with forward error correction coding exhibits a diversity gain when compared to a single subband conventional transmission method, due to the signal interleaving over multiple parallel subbands. In the presence of MT jamming, the multi-subband signal is more robust to tone jamming than a single subband solution. For the simulated embodiments, an MT jammer must increase its power by a further 4 dB compared to the conventional system to induce irreducible errors and render the multi-subband communication inoperable. The multi-subband transmission scheme of the present invention requires no extra power or bandwidth to realize the performance gains described, compared to the conventional single subband solution. Additionally, there are no requirements for jammer information to be known in order to obtain performance benefits. If jammer information is available, the proposed system can make adaptive adjustments to improve performance further, for example, by careful choice of subband frequencies.

The present invention has been filly described in conjunction with the exemplary embodiments thereof with reference to the accompanying drawings. Of course numerous other embodiments may be envisioned without departing from the spirit and scope of the invention; it is to be understood that the various changes and modifications to the aforedescribed embodiments may be apparent to those skilled in the art. Such changes and modifications are to be understood as included within the scope of the present invention as defined by the appended claims, unless they depart therefrom.

1) A method of transmitting an input data stream via a radio link, the input data stream having an input data rate, the method comprising the steps of:
a) converting the input data stream into a plurality of parallel data sub-streams using serial-to-parallel conversion, wherein each of the parallel data sub-streams carries a different portion of the input data stream, each portion defining a sub-stream data rate;
b) generating a carrier waveform having a hopping frequency for each parallel data sub-stream;
c) modulating each carrier waveform using the respective data sub-stream according to a modulation format to produce a frequency-hopping subband signal, said sub-band signal having a subband bandwidth related to the corresponding sub-stream data rate; and,
d) forming a multi-subband frequency-hopping RF signal from the frequency-hopping subband signals for transmitting thereof via the radio link using an RF transmitting unit;
wherein each of the frequency-hopping subband signals has a different frequency hopping sequence and a frequency hopping range, the frequency hopping ranges being such that at least two of the frequency hopping ranges have at least one common frequency.

2) A method according to claim 1, wherein the frequency hopping sequences form a plurality of pseudo-random orthogonal hopping sequences.

3) A method according to claim 2, wherein step (a) comprises the step of encoding the input data stream using one of: forward error correction coding, cyclic redundancy check coding, and data symbol interleaving.

4) A method according to claim 2, wherein each data sub-stream comprises a plurality of symbols, each symbol having a size, and,
wherein each of the sub-stream of symbols is formed from a different portion of the input stream of data.

5) A method according to claim 2, further comprising adding a pilot sequence of symbols to at least one of the data sub-streams.

6) A method according to claim 4, wherein at least one selected from the group consisting of:
a number of the data sub-streams,
the frequency hopping range of at least one of the data sub-streams,
the sub-stream data rate of at least one of the data sub-streams,
the symbol size for symbols in at least one of the data sub-streams, and
the modulation format for at least one of the data sub-streams, is adjustable in dependence to one of: the input data rate, frequency bands available for the RF transmission, and external signal interference in the radio link.

7) A method according to claim 1, wherein at least two of the parallel data sub-streams from the Q parallel data sub-streams have substantially a same frequency-hopping range.

8) A method according to claim 1 wherein at least one of the frequency-hopping ranges is non-contiguous.

9) A method according to claim 1 wherein there are 2 to 8 parallel data sub-streams.

10) A method of receiving a stream of data transmitted by a transmitter using the method of claim 1, the method of receiving comprising the steps of:
A) receiving the multi-subband frequency-hopping RF signal with an RF receiving unit, the multi-subband frequency-hopping RF signal comprising the plurality of frequency-hopping subband signals, each centered at a different hopping frequency known to the receiver;
B) converting the multi-subband frequency-hopping RF signal into a plurality of baseband signals corresponding to the plurality of frequency-hopping subband signals;
C) extracting a plurality of parallel sub-streams of received data symbols from the plurality of baseband signals, wherein each of the parallel sub-streams is extracted from a baseband signal corresponding to a different frequency-hopping subband signal; and,
D) combining the extracted plurality of parallel sub-streams of received data symbols into a sequential stream of data symbols using a parallel-to-serial conversion.

11) A method according to claim 10, wherein step (C) includes producing a plurality of parallel sub-sequences of received data symbols by performing, for at least one of the baseband signals, the steps of:
sampling the at least one of the baseband signals to obtain a sequence of received waveform samples;
identifying a pilot sequence in the sequence of received waveform samples;
performing subband-level channel estimation using the identified pilot sequence; and,
performing subband-level channel equalizing upon the sequence of received waveform samples to obtain one of the plurality of parallel sub-streams of received data symbols.

12) A method according to claim 10, wherein step (D) comprises the steps of:
combining the plurality of parallel sub-streams of the received data symbols into a combined sequence of data symbols using the parallel-to-serial conversion; and,
de-coding the combined sequence of received data symbols to form the sequential stream of data symbols.

13) A method according to claim 10, further comprising the steps of:
estimating a transmission quality characteristic for each of the received frequency-hopping subband signals, and
forming a feedback signal for communicating to the transmitter for adaptively changing a characteristic of the multi-subband frequency-hopping RF signal at the transmitter.

14) A method according to claim 13, wherein the characteristic of the multi-subband frequency-hopping RF signal is one of:
a number of the frequency-hopping subband signals in the multi-subband frequency-hopping RF signal,
the frequency bandwidth of one of the frequency-hopping subband signals,
the frequency hopping range of one of the frequency-hopping subband signal,
the frequency hopping sequence of one of the frequency-hopping subband signal, and
the modulation format for one of the frequency-hopping subband signal.

15) A multi-subband frequency-hopping transmitter for transmitting an input stream of data, comprising:
input data conversion means for converting the input data stream into a plurality of parallel data sub-streams using serial-to-parallel conversion, each of the parallel data sub-streams carrying a different portion of the input data stream;
waveform generating means for generating a frequency-hopping carrier waveform for each of the parallel data sub-streams, each of the frequency-hopping carrier waveforms having a different hopping frequency;
modulating means for modulating each of the frequency-hopping carrier waveforms with a corresponding data sub-stream using a modulation format to produce the frequency-hopping subband signals;
an RF transmitting unit outputting the frequency-hopping subband signals for transmitting via a radio link to a receiver;
wherein each of the frequency-hopping carrier waveforms has a distinct frequency hopping sequence and a frequency hopping range, the frequency hopping ranges being such that at least two of the frequency hopping ranges have at least one common frequency.

16) A transmitter according to claim 15, further comprising means for inserting a pilot sequence of symbols in at least one of the plurality of parallel data sub-streams.

17) A transmitter according to claim 15, wherein the data conversion means comprises an encoder and a serial-to-parallel conversion unit.

18) A transmitter according to claim 15, capable of adaptively changing at least one selected from the group consisting of:
a number of subband signals;
the portion of the input data stream carried by one of the parallel data sub-streams, the portion defining a data rate of said data sub-stream;
the frequency-hopping range and the frequency-hopping sequence of one of the frequency-hopping subband signals; and,
the modulation format of one of the frequency-hopping subband signals.

19) A multi-subband receiver for receiving a stream of data symbols transmitted using the transmitter of claim 15, comprising:
an RF receiving unit for receiving a multi-subband RF signal comprising a plurality of frequency-hopping subband signals and for converting each of the plurality of frequency-hopping subband signals into a baseband signal;
data extracting means for extracting a plurality of parallel sub-streams of received symbols from the plurality of baseband signals; and,
output data conversion means for converting the plurality of parallel sub-streams of received symbols into a sequential stream of data symbols using a parallel-to-serial conversion.

20) A receiver according to claim 19, wherein the data extracting means comprises:
an A/D converter for obtaining a sequence of received waveform samples from each of the baseband signals by sampling thereof;
channel estimating means for identifying a pilot sequence in at least one of the sequences of received waveform samples, and for providing subband-level channel estimation based on the identified pilot sequence;
channel equalizing means for performing subband-level channel equalization upon each of the sequences of received waveform samples based on the subband-level channel estimation provided by the channel estimating means to form the plurality of parallel sub-streams of received symbols.

21) A receiver according to claim 19, wherein the output data conversion means comprises:
a parallel to serial converter for combining the plurality of parallel sub-streams of received symbols into the sequential stream of received data symbols; and,
a decoder for de-coding the sequential stream of data symbols.
